(19) United States
(12) Patent Application Publication
(10) Pub. No.: US 2025/0346478 A1
(43) Pub. Date: Nov. 13, 2025

(54) WATER OUTLET UNIT AND WATER PURIFIER COMPRISING SAME

(71) Applicant: COWAY CO., LTD., Gongju-si (KR)

(72) Inventors: Hee Joo KANG, Seoul (KR); Jong Hwan LEE, Seoul (KR); Hee Do JUNG, Seoul (KR); Chan Jung PARK, Seoul (KR); Hyun Kang LEE, Seoul (KR); Yoo Won OH, Seoul (KR); Seong Min PARK, Seoul (KR); Dong Min OH, Seoul (KR); Da Woon JUNG, Seoul (KR); Seung Won LEE, Seoul (KR); Byung Hyo YE, Seoul (KR); Hyun Goo KIM, Seoul (KR)

(73) Assignee: COWAY CO., LTD., Gongju-si (KR)

(21) Appl. No.: 18/870,538

(22) PCT Filed: May 4, 2023
(86) PCT No.: PCT/KR2023/006093

§ 371 Date: Nov. 29, 2024

(30) Foreign Application Priority Data
Jun. 3, 2022 (KR) 10-2022-0068294

(51) Int. Cl. B67D 1/08

(52) U.S. Cl. CPC B67D 1/0897; B67D 2210/00047

(57) ABSTRACT

In accordance with one embodiment of the present disclosure, a water dispensing unit for a water purifier comprises: a first flow pipe providing a first dispensing passage for dispensing hot water; and a second flow pipe providing a second dispensing passage for dispensing purified water or cold water, wherein the first flow pipe includes: a hot water pipe section; and a nozzle section extending from a lower end of the hot water pipe section and having an inner diameter smaller than an inner diameter of the hot water pipe section in a downward direction to delay dispensing of the hot water.

### TECHNICAL FIELD

The present disclosure relates to a water dispensing unit and a water purifier including the same.

### BACKGROUND ART

In general, a water purifier is a device that receives water from a water source such as a tap, filters the water into purified water through a filter provided therein, and then provides the purified water to a user. The water purifiers can provide not only purified water but also hot water to the user.

In this regard, Korean Patent Application Publication No. 10-2018-0133611 entitled “Water purifier faucet” (Patent Document 1) of the present applicant discloses a water outlet pipe member, a faucet member coupled to an end of the water outlet pipe member, and a detachable jig detachably coupled to the faucet member. The water outlet pipe member of Patent Document 1 is composed of a cold water and purified water supply pipe member that supplies cold water or purified water, and a hot water pipe member that supplies hot water.

Meanwhile, in order to provide hot water to users, the water purifier instantly heats purified water to 80° C. or higher through an instantaneous water heater module. In addition, recent water purifiers instantaneously heat water to even higher temperatures to provide hot water to users. Such hot water may be vaporized due to various reasons such as pressure changes due to flow, vortex formation, etc., to generate bubbles, and the bubbles may be discharged together with the hot water. Therefore, when hot water is dispensed from the water purifier, the bubbles may cause hot water stream to splash in all directions.

However, Patent Document 1 discloses only the configuration of the hot water pipe member extending linearly and does not disclose the configuration for removing steam generated in the hot water pipe member that supplies hot water. Therefore, it fails to address the problem that the hot water is not dispensed in a straight stream but splashes in all directions when dispensed.

Meanwhile, in recognizing the problems related to bubbles when dispensing hot water as described above, there have been studies to remove bubbles generated when hot water is dispensed from a water purifier,.

In relation to this, Korean Patent Application Publication No. 10-2012-0075799 entitled “Hot water dispensing valve” (Patent Document 2) of the present applicant discloses a hot water dispensing valve including a dispensing-side flow path for dispensing hot water and a bubble crushing member disposed in the dispensing-side flow path to allow hot water to pass therethrough and remove bubbles in the hot water.

However, the bubble crushing member of the hot water dispensing valve in Patent Document 2 is formed in a mesh shape to allow hot water to pass through and is disposed in the dispensing-side flow path, which may reduce the flowability of the dispensed hot water. In addition, there is a problem that the flow path structure of the water purifier becomes more complicated due to the bubble crushing member of the hot water dispensing valve in Patent Document 2. Further, the bubble crushing member of Patent Document 2 may reduce the flowability of hot water, causing residual water may remain in the flow path, which may deteriorate the hygiene of the water purifier.

In addition, Korean Patent Application Publication No. 10-2013-0128591 entitled “Steam separation device” (Patent Document 3) of the present applicant discloses a lower body provided with a steam outlet for discharging steam separated from hot water, a hot water outlet for discharging hot water from which steam has been separated to the outside, and a separation member for separating steam contained in the hot water, along with an upper body provided with a steam outlet.

However, since the upper body, which is the upper structure of the steam separation device, occupies a relatively large volume in the overall structure of the water purifier, it is difficult to apply the steam separation device to slim-design water purifiers. In addition, there is a problem that the steam escaping through the hot water outlet may generate condensation water on the surfaces of other components of the water purifier provided inside the water purifier, and this condensation water may be discharged to the outside of the water purifier, causing inconvenience in use. Further, since the upper part of the discharge flow path is exposed to atmospheric pressure, the differential pressure in the flow path is not applied to the hot water outlet of the steam separation device, and the speed of hot water discharged from the hot water outlet is very fast, which may cause hot water to splash in all directions when dispensed.

As such, when hot water is dispensed, if the hot water splashes in all directions, the user using the water purifier may suffer mild burns due to the hot water splashing in all directions. Afterwards, the user may be reluctant to use hot water from the water purifier, which may reduce the usability of the water purifier. In addition, when hot water is dispensed from the water purifier, the hot water stream may splash out of a container and contaminate the surrounding area.

Accordingly, there is a need for technology that can separate steam generated from hot water in the water purifier and maintain a stable water stream when the hot water is dispensed from the water purifier.

### ART DOCUMENT

### Patent Document

Patent Document 1: Korean Patent Application Publication No. 10-2018-0133611 (published on Dec. 17, 2018)

Patent Document 2: Korean Patent Application Publication No. 10-2012-0075799 (published on Jul. 9, 2012)

Patent Document 3: Korean Patent Application Publication No. 10-2013-0128591 (published on Nov. 17, 2013)

### DETAILED DESCRIPTION OF INVENTION

### Technical Problems

In view of the above, embodiments of the present disclosure provide a water dispensing unit capable of mechanically separating steam from hot water to ensure stable dispensing of hot water, and a water purifier including the same.

In addition, embodiments of the present disclosure provide a water dispensing unit capable of reducing the formation of vortices due to bubbles during the dispensing of hot water, and a water purifier including the same.

### Technical Solution

In accordance with one embodiment of the present disclosure, a water dispensing unit for a water purifier comprises: a first flow pipe providing a first dispensing passage for dispensing hot water; and a second flow pipe providing a second dispensing passage for dispensing purified water or cold water, wherein the first flow pipe includes: a hot water pipe section; and a nozzle section extending from a lower end of the hot water pipe section and having an inner diameter smaller than an inner diameter of the hot water pipe section in a downward direction to delay dispensing of the hot water.

Further, the first flow pipe may further include a buffer section provided at an upper portion of the hot water pipe section so that steam generated from the hot water stagnates in the buffer section.

Further, the water dispensing unit may further comprise: a hot water supply pipe that communicates with a side portion of the hot water pipe section and supplies the hot water to the hot water pipe section, wherein the buffer section is disposed above the hot water supply pipe and extends upward.

Further, the hot water pipe section may have a hot water inner surface tapered downward to have an inner diameter that becomes smaller downward, and the first dispensing passage is formed by the hot water inner surface.

Further, the nozzle section may include: a first nozzle section extending downward continuously from a lower end of the hot water pipe section and having a first inner surface that is tapered downward to have an inner diameter gradually decreasing downward; and a second nozzle section extending downward continuously from a lower end of the first nozzle section and having a second inner surface tapered to have an inner diameter smaller than that of the first inner surface or formed to extend parallel to an up-down direction.

Further, a thickness between the inner diameter and the outer diameter of the second nozzle section may be thicker than a thickness between the inner diameter and the outer diameter of the first nozzle section, and the thickness between the inner diameter and the outer diameter of the first nozzle section is thicker than a thickness between the inner diameter and the outer diameter of the hot water pipe section.

Further, the first flow pipe and the second flow pipe may be formed integrally.

Further, a water purifier comprises: a main body; and a water dispensing unit installed in the main body for dispensing hot water, purified water, or cold water, wherein the water dispensing unit includes: a first flow pipe providing a first dispensing passage for dispensing hot water; and a second flow pipe providing a second dispensing passage for dispensing purified water or cold water, wherein the first flow pipe includes: a hot water pipe section; and a nozzle section extending from a lower end of the hot water pipe section and having an inner diameter smaller than an inner diameter of the hot water pipe section in a downward direction to delay dispensing of the hot water.

### EFFECT OF INVENTION

According to embodiments of the present disclosure, by forming the steam buffer space in the upper portion of the first flow pipe through which hot water is dispensed, steam from the hot water can be mechanically separated, thereby reducing the formation of vortices caused by bubbles.

In addition, according to embodiments of the present disclosure, hot water can be pushed in the direction of gravity by using steam that is stagnant in the steam buffer space, thereby maintaining the hot water stream in a straight shape.

Further, according to embodiments of the present disclosure, by providing the stabilization section in which hot water stagnates at the lower portion of the first flow pipe from which hot water is dispensed, the hot water can be stabilized by delaying the dispensing time of the hot water, which significantly enhances the usability of hot water for the user and contributes to maximizing the quality of the product.

In addition, according to embodiments of the present disclosure, since the thickness between the inner diameter and the outer diameter of the nozzle section located on the lower side of the first flow pipe is thicker than the thickness between the inner diameter and the outer diameter of the nozzle section located on the upper side of the first flow pipe, deformation of the nozzle section due to the high temperature of the hot water can be prevented in advance.

### BRIEF DESCRIPTION OF THE DRAWINGS

FIG. 1 is a perspective view showing a water purifier.

FIG. 2 is a block diagram schematically showing the configuration of the water purifier.

FIG. 3 is a cross-sectional view taken along line I-I of the water purifier in FIG. 1.

FIG. 4 is a perspective view showing the assembled state of a water dispensing unit, a faucet, and a replaceable tube module of the water purifier.

FIG. 5 is a perspective view showing the water dispensing unit.

FIG. 6 is a cross-sectional view taken along line II-II in FIG. 5.

FIG. 7 is a cross-sectional view taken along line III-III in FIG. 5.

FIG. 8 is a cross-sectional view taken along line IV-IV in FIG. 7.

### MODE FOR CARRYING OUT THE INVENTION

Hereinafter, specific embodiments for implementing the technical ideas of the present disclosure will be described in detail with reference to the drawings.

In addition, in describing the present disclosure, when it is determined that a detailed description of the relevant known configuration or function may obscure the main idea of the present disclosure, the detailed description thereof will be omitted.

Further, when a component is mentioned to be “connected to”, “supported on”, “flowing into”, “flowing to”, “coupled to”, or “extracted to” another component, it should be understood that it may be directly connected to, supported on, flowing into, flowing to, coupled to, or extracted to another component, but there may be other components therebetween.

The terms used in the present specification are used merely to describe the specific embodiments and are not intended to limit the present disclosure. Singular expressions include the plural unless the context clearly indicates otherwise.

Furthermore, the terms containing ordinal numbers, such as first, second, etc., may be used to describe various components, but the components are not limited by such terms. These terms are used only to distinguish one component from another.

The meaning of “include” used in the present specification is intended to specify certain features, areas, integers, steps, operations, elements, and/or components, and is not intended to exclude the existence or the addition of other specific features, areas, integers, steps, operations, elements, components, and/or groups.

Further, in the present specification, it should be noted that expressions such as upper, lower, and the like are described with reference to the drawings and may be expressed differently when the orientation of the subject matter is changed.

Hereinafter, the specific configuration of a water purifier 1 will be described with reference to the drawings.

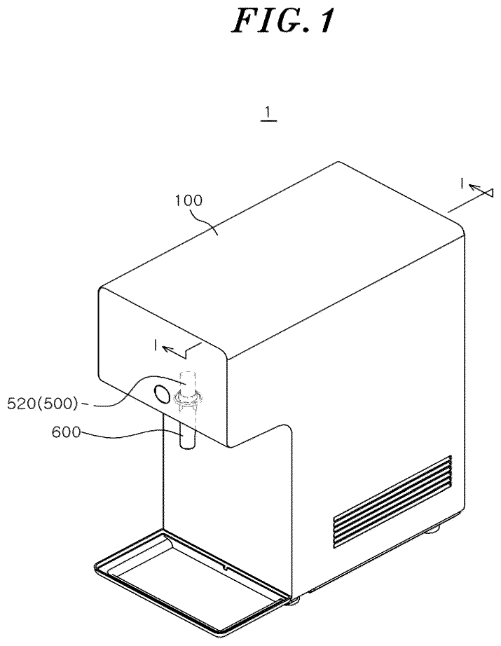

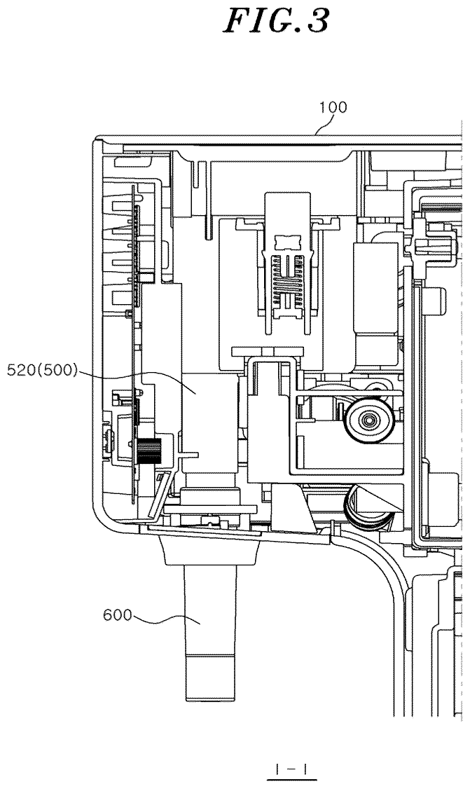

Referring to FIGS. 1 to 3, the water purifier 1 can provide clean water to a user by filtering water supplied from an external source. The water purifier 1 may include a main body 100, a filter 200, a heater 300, a cooler 400, a flow path assembly 500, and a faucet 600.

Before providing a detailed description, water that flows into the water purifier 1 from the outside can be categorized into raw water, purified water, cold water, and hot water.

Hereinafter, water that flows into the water purifier 1 from the outside but has not passed through the filter 200 is defined as raw water, while water that has been filtered through the filter 200 is defined as purified water. In addition, water filtered through the filter 200 that has been cooled to a predetermined temperature or below by the cooler 400 is defined as cold water, and water filtered through the filter 200 that has been heated to a preset temperature or higher by the heater 300 is defined as hot water.

The main body 100 may provide the overall appearance of the water purifier 1. The main body 100 may be in the form of a case provided to surround at least some of the main components of the water purifier 1. The main body 100 may be formed by assembling a plurality of covers and frames together by bolts or the like. The main body 100 may support various types of water purifier components for filtering raw water. For example, the main body 100 may support a filter 200, a heater 300, a cooler 400, and a flow path assembly 500.

The filter 200 may filter raw water flowing into the water purifier 1 into purified water. The raw water may flow into the filter 200 through a flow path 511 of a flow path unit 510 to be described later. The purified water filtered by the filter 200 may flow through a first discharge path 512 and a second discharge path 513 of the flow path unit 510, which will be described later.

The heater 300 may provide hot water by heating purified water to a preset temperature or higher. The hot water provided by the heater 300 may be provided to a water dispensing unit 520, which will be described later, through the first discharge path 512.

The cooler 400 may provide cold water by cooling purified water to the predetermined temperature or below. The cold water provided by the cooler 400 may be provided to the water dispensing unit 520 through the second discharge path 513.

The flow path assembly 500 may be disposed inside the main body 100 and provide passages for the flow of raw water, hot water, and cold water and purified water in the main body 100. The flow path assembly 500 may include a flow path unit 510, a water dispensing unit 520, and a replaceable tube module 530.

The flow path unit 510 may provide the passages for the flow of raw water, hot water, and cold water and purified water in the main body 100. The flow path unit 510 may include a flow path 511, a first discharge path 512, and a second discharge path 513.

The flow path 511 can provide a passage for raw water flowing into the filter 200 from the outside to flow and a passage for purified water filtered by the filter 200 to be discharged. The first discharge path 512 branches off from the flow path 511 and may provide a passage for purified water flowing from the filter 200 to flow to the heater 300. The second discharge path 513 branches off from the flow path 511 and may provide a passage for purified water flowing from the filter 200 to flow to the cooler 400.

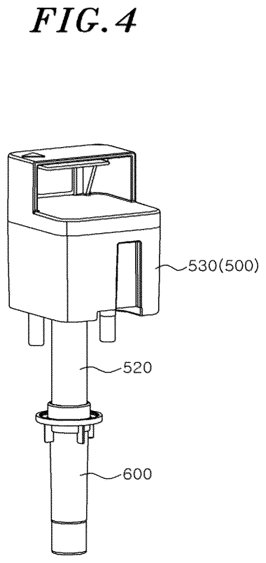

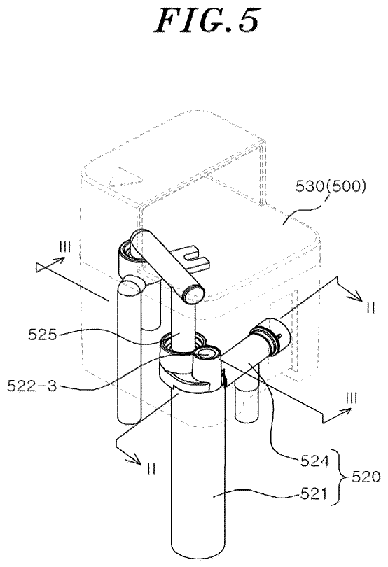

Referring to FIGS. 4 and 5, the water dispensing unit 520 may be supported on the main body 100. The water dispensing unit 520 may be configured to discharge purified water, cold water, and hot water flowing within the replaceable tube module 530 to the outside. For example, the water dispensing unit 520 may be configured to discharge one of purified water, cold water, and hot water to the outside based on a user's selection. In addition, the water dispensing unit 520 may be provided on a front side of the main body 100 and may be open in a downward direction.

The faucet 600 may be detachably connected to a lower end portion of the water dispensing unit 520. The faucet 600 can guide hot water, purified water or cold water supplied from the water dispensing unit 520 to the outside. In the present embodiment, hot water, purified water or cold water dispensed from the water dispensing unit 520 is dispensed through the faucet 600, but the present disclosure is not limited thereto, and the hot water, purified water or cold water may be dispensed directly from the water dispensing unit 520 to the outside without passing through a separate faucet 600.

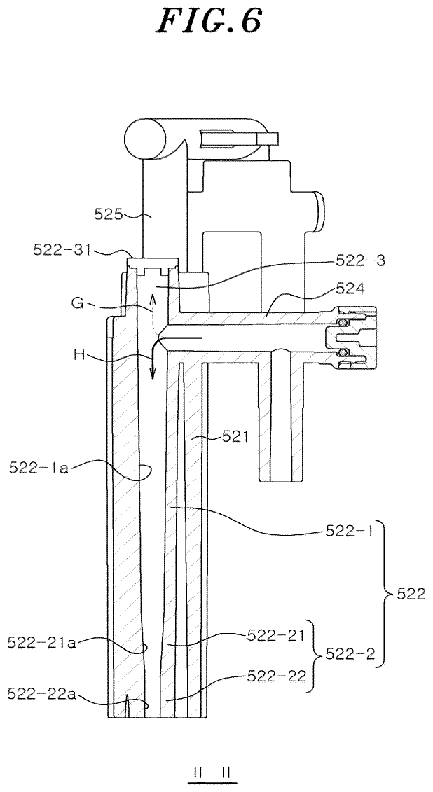

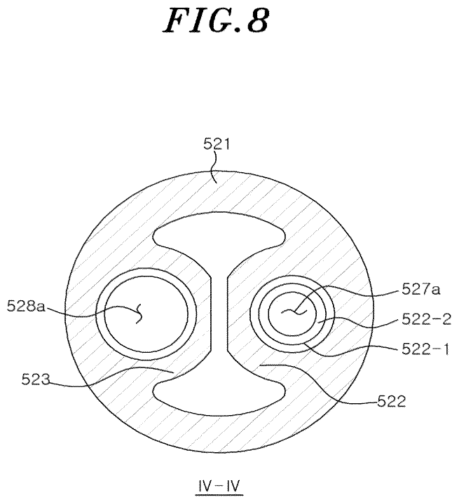

Referring to FIGS. 6 and 8, the water dispensing unit 520 may include an outer pipe 521, a first flow pipe 522, a second flow pipe 523, a hot water supply pipe 524, a cold water supply pipe 525, a first water outlet 527, and a second water outlet 528.

The outer pipe 521 may be a cover pipe that surrounds the first flow pipe 522 and the second flow pipe 523. The outer pipe 521 may be formed integrally with at least a portion of the first flow pipe 522 and the second flow pipe 523. For example, one side of the outer pipe 521 may be formed integrally with a portion of a sidewall of the first flow pipe 522, and the other side of the outer pipe 521 may be formed integrally with a portion of a sidewall of the second flow pipe 523. In addition, at least a portion of the first flow pipe 522 and the second flow pipe 523 may be formed integrally.

The first flow pipe 522 may provide a first dispensing passage 522a for dispensing hot water. A hot water supply pipe 524, which extends in a direction different from an up-down direction, may be connected to a side of the first flow pipe 522 to communicate with the first flow pipe 522. The first flow pipe 522 may be configured to communicate with the hot water supply pipe 524 at a position lower than its top end. In other words, the first flow pipe 522 may communicate with the hot water supply pipe 524 at a position lower than a buffer section 522-3 which will be described later. When hot water is supplied from the hot water supply pipe 524 to the first flow pipe 522, steam G generated from the hot water moves to the upper side in the first flow pipe 522, and hot water H from which some of the steam is separated (hot water from which the steam has escaped) moves to the lower side in the first flow pipe 522. As the steam G stagnates at the upper side in the first flow pipe 522, the steam can push the steam-separated hot water H downward (in the direction of gravity) in the first flow pipe 522.

The first flow pipe 522 may include a hot water pipe section 522-1, a nozzle section 522-2, and a buffer section 522-3.

The hot water pipe section 522-1 may provide a passage for hot water passing through the hot water supply pipe 524 to flow to the nozzle section 522-2. The hot water pipe section 522-1 may have a hot water inner surface 522-1a tapered downward so that the inner diameter becomes smaller in the downward direction. The inner wall of the first dispensing passage 522a provided in the hot water pipe section 522-1 may be formed by the hot water inner surface 522-1a.

The nozzle section 522-2 may be formed to extend from the lower end of the hot water pipe section 522-1. The nozzle section 522-2 may have a smaller inner diameter than the inner diameter of the hot water pipe section 522-1 that becomes smaller in the downward direction. For example, the nozzle section 522-2 may include a first nozzle section 522-21 and a second nozzle section 522-22 having an inner diameter smaller than that of the first nozzle section 522-21.

The first nozzle section 522-21 may be connected to the second nozzle section 522-22 by continuously extending downward from the lower end of the hot water pipe section 522-1 without any notches. The first nozzle section 522-21 may have a first inner surface 522-21a tapered downward to have an inner diameter gradually decreasing downward. The gradient of decreasing inner diameter of the first nozzle section 522-21 may be greater than the gradient of decreasing inner diameter of the hot water pipe section 522-1. In other words, the reduction in inner diameter per unit length in the up-down direction in the first nozzle section 522-21 may be greater than that in the hot water pipe section 522-1. The inner wall of the first dispensing passage 522a provided in the first nozzle section 522-21 may be formed by the first inner surface 522-21a.

Since the first nozzle section 522-21 has a funnel-shaped inner surface with the inner diameter that becomes smaller in the downward direction than the inner diameter of the hot water pipe section 522-1, a stabilization zone in which a portion of the hot water stagnates may occur in the first nozzle section 522-21. In the stabilization zone in which a portion of the hot water stagnates in the first nozzle section 522-21, the flow rate of the hot water is increased due to the narrower inner diameter surface to significantly reduce the vortex phenomenon of the hot water, so that the dispensed hot water can be stabilized.

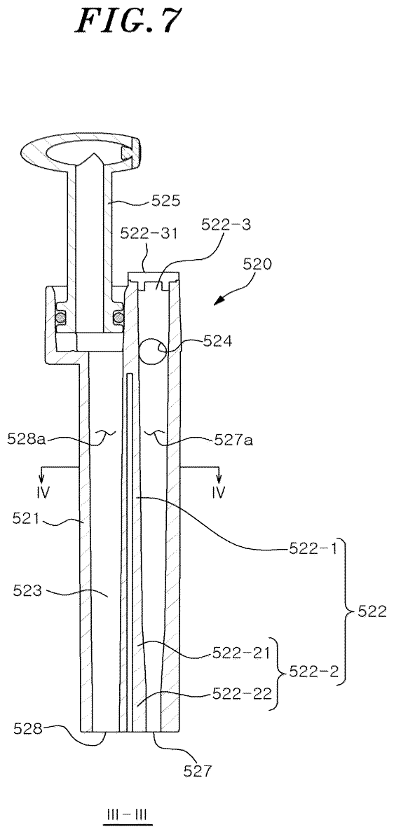

Referring to FIG. 7, the thickness between the inner diameter and the outer diameter of the first nozzle section 522-21 may be thicker than the thickness between the inner diameter and the outer diameter of the hot water pipe section 522-1. Based on the same outer diameter, since the thickness between the inner diameter and the outer diameter of the first nozzle section 522-21 is thicker than the thickness between the inner diameter and the outer diameter of the hot water pipe section 522-1, the first nozzle section 522-21 may have the funnel-shaped inner surface with the inner diameter that becomes smaller than the inner diameter of the hot water pipe section 522-1 downward in the first flow pipe 522.

The second nozzle section 522-22 may extend continuously downward from the lower end of the first nozzle section 522-21. The second nozzle section 522-22 may have a second inner surface 522-22a tapered to have an inner diameter smaller than that of the first inner surface 522-21a or it may be extended parallel to the up-down direction. The second inner surface 522-22a may form an inner wall of the first dispensing passage 522a provided in the second nozzle section 522-22.

When the first flow pipe 522 has a shape extending in the up-down direction with the same outer diameter, the thickness between the inner diameter and the outer diameter of the second nozzle section 522-22 may be thicker than the thickness between the inner diameter and the outer diameter of the first nozzle section 522-21.

As such, the thickness between the inner diameter and the outer diameter of the first nozzle section 522-21 may be thicker than the thickness between the inner diameter and the outer diameter of the hot water pipe section 522-1, and the thickness between the inner diameter and the outer diameter of the second nozzle section 522-22 may be thicker than the thickness between the inner diameter and the outer diameter of the first nozzle section 522-21.

The buffer section 522-3 may provide a steam buffer space where steam separated from hot water can flow in and stagnate. The buffer section 522-3 may be extended upward from the hot water pipe section 522-1 and provided above the hot water supply pipe 524. In addition, a buffer cap 522-31 may be detachably provided at the upper end of the hot water pipe section 522-1 to selectively open the inside of the buffer section 522-3. When the steam G moves toward the upper end of the first flow pipe 522, the steam G contained in the hot water or generated from the hot water can flow into the vapor buffer space. The steam G that flows into the buffer section 522-3 can push the hot water in the first flow pipe 522 downward (in the direction of gravity), which results in straight water stream.

The second flow pipe 523 may provide a second dispensing passage 523a for dispensing purified water or cold water. An upper end of the second flow pipe 523 may be connected in communication with the cold water and purified water supply pipe 525. The second flow pipe 523 can discharge purified water or cold water supplied through the cold water and purified water supply pipe 525 to the outside through the faucet 600.

The hot water supply pipe 524 may provide a passage for hot water to flow. An end of the hot water supply pipe 524 may be connected to a side portion of the first flow pipe 522. The hot water supply pipe 524 can guide hot water heated to a certain temperature or higher by the heater 300 to the first flow pipe 522.

The cold water and purified water supply pipe 525 may provide a passage for purified

water or cold water to flow. An end of the cold water supply pipe 525 may be connected to the upper end of the second flow pipe 523. The cold water supply pipe 525 can guide purified water or cold water that has passed through the filter and the cooler to the second flow pipe 523.

The first water outlet 527 may be a hole for dispensing hot water. The first water outlet 527 may be provided at the bottom end of the first flow pipe 522. The first water outlet 527 may be detachably connected to communicate with the upper portion of the faucet 600. For example, hot water supplied from the first discharge path 512 may move downward through the first dispensing passage 522a and flow into the faucet 600.

The second water outlet 528 may be a hole for dispensing cold water. The second water outlet 528 may be provided at the bottom end of the second flow pipe 523. The second water outlet 528 may be detachably connected to communicate with the upper portion of the faucet 600. The cold water supplied from the second discharge path 513 may flow downward through the second dispensing passage 523a and flow into the faucet 600. The first water outlet 527 and the second water outlet 528 may be arranged adjacent to each other.

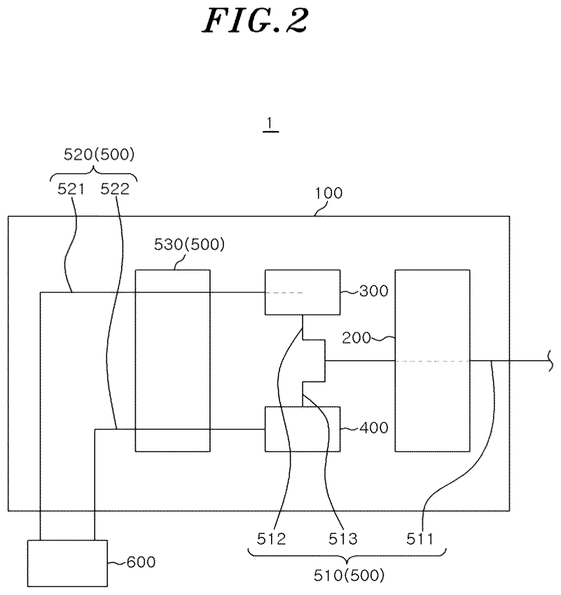

Referring again to FIG. 2, the replaceable tube module 530 may provide a passage through which the first discharge path 512 and the first water outlet 527 are connected, and a passage through which the second discharge path 513 and the second water outlet 528 are connected. The replaceable tube module 530 may be detachably coupled to the water dispensing unit 520.

The faucet 600 may be detachably connected to the water dispensing unit 520 to be in communication with the water dispensing unit 520. The lower portion of the faucet 600 may extend downward from the main body 100. The upper portion of the faucet 600 may be connected to the water dispensing unit 520 within the main body 100. Hot water, cold water, or purified water flowing from the water dispensing unit 520 can be discharged through the lower portion of the faucet 600.

Hereinafter, the operational effect of the water purifier 1 with the configuration described above will be described.

When hot water from the water purifier is provided to a user, as hot water is supplied from the hot water supply pipe 524 to the first flow pipe 522, some of the steam G generated from the hot water moves to the steam buffer space provided in the upper portion of the first flow pipe 522 and may stagnate and remain in the steam buffer space. The stagnant steam G in the steam buffer space pushes the hot water downward (in the direction of gravity) in the first flow pipe 522, allowing the hot water to be dispensed in a stable stream without splashing around.

In addition, since the first flow pipe 522 through which hot water is dispensed has a shape with a narrowing inner diameter, the flow rate of hot water becomes fast and the vortex phenomenon of hot water is significantly reduced, thereby stabilizing the flow of the hot water during dispensing.

Although the embodiments of the present disclosure have been described above as specific embodiments, these are merely examples. The present disclosure is not limited to the above and should be construed as having the broadest scope according to the technical idea disclosed in the present specification. Those skilled in the art may implement a pattern of a shape not specified above by combining/substituting the disclosed embodiments, without departing from the scope of the present disclosure. In addition, those skilled in the art may easily change or modify the embodiments disclosed based on the present specification, and it is clear that such changes or modifications also fall within the scope of the present disclosure.

What is claimed is:

1. A water dispensing unit for a water purifier, comprising:
a first flow pipe providing a first dispensing passage for dispensing hot water; and
a second flow pipe providing a second dispensing passage for dispensing purified water or cold water,
wherein the first flow pipe includes:
a hot water pipe section; and
a nozzle section extending from a lower end of the hot water pipe section and having an inner diameter smaller than an inner diameter of the hot water pipe section in a downward direction to delay dispensing of the hot water.

2. The water dispensing unit of claim 1, wherein the first flow pipe further includes a buffer section provided at an upper portion of the hot water pipe section so that steam generated from the hot water stagnates in the buffer section.

3. The water dispensing unit of claim 2, further comprising:
a hot water supply pipe that communicates with a side portion of the hot water pipe section and supplies the hot water to the hot water pipe section,
wherein the buffer section is disposed above the hot water supply pipe and is extended upward.

4. The water dispensing unit of claim 1, wherein the hot water pipe section has a hot water inner surface tapered downward to have an inner diameter that becomes smaller downward, and
the first dispensing passage is formed by the hot water inner surface.

5. The water dispensing unit of claim 4, wherein the nozzle section includes:
a first nozzle section extended downward continuously from a lower end of the hot water pipe section and having a first inner surface that is tapered downward to have an inner diameter gradually decreasing downward; and
a second nozzle section extended downward continuously from a lower end of the first nozzle section and having a second inner surface tapered to have an inner diameter smaller than that of the first inner surface or formed to extend parallel to an up-down direction.

6. The water dispensing unit of claim 5, wherein a thickness between the inner diameter and the outer diameter of the second nozzle section is thicker than a thickness between the inner diameter and the outer diameter of the first nozzle section, and
the thickness between the inner diameter and the outer diameter of the first nozzle section is thicker than a thickness between the inner diameter and the outer diameter of the hot water pipe section.

7. The water dispensing unit of claim 1, wherein the first flow pipe and the second flow pipe are formed integrally.

8. A water purifier comprising:
a main body; and
a water dispensing unit installed in the main body for dispensing hot water, purified water, or cold water,
wherein the water dispensing unit includes:
a first flow pipe providing a first dispensing passage for dispensing hot water, and
a second flow pipe providing a second dispensing passage for dispensing purified water or cold water,
wherein the first flow pipe includes:
a hot water pipe section; and
a nozzle section extended from a lower end of the hot water pipe section and having an inner diameter smaller than an inner diameter of the hot water pipe section in a downward direction to delay dispensing of the hot water.
